(19) United States
(12) Patent Application Publication
(10) Pub. No.: US 2008/0020772 A1
(43) Pub. Date: Jan. 24, 2008

(54) Systems and methods for reduced overhead in wireless communication networks having SDMA modulation

(75) Inventors: Manyuan Shen, Bellevue, WA (US); Guanbin Xing, Issaquah, WA (US)

Correspondence Address: FULBRIGHT & JAWORSKI L.L.P, 2200 ROSS AVENUE, SUITE 2800, DALLAS, TX, 75201-2784, US

(73) Assignee: Adaptix, Inc., Seattle, WA (US)

(21) Appl. No.: 11/491,554

(22) Filed: Jul. 21, 2006

(51) Int. Cl. H04Q 7/20

(52) U.S. Cl. 455/443

(57) ABSTRACT

Advantage is taken of the fact that downlink quality is always known at a mobile station. Thus, a base station may use preference information from the mobile station as a basis for assigning a channel, rather than requiring the details of channel conditions. In one embodiment, the base station pre-selects orthogonal beam-forming vectors for subcarriers and broadcasts the channels into different sectors of the region served by base station. The mobile stations then determine a priority (based for example on received quality) order of the codes of the received vectors. This priority order is sent uplink to the base station and the base station then, based on a priority listing of vectors from the mobile station, selects the downlink sub-channel. The vectors may be established with some degree of randomness, or may be based on a desired beam coverage profile.

### TECHNICAL FIELD

This invention relates generally to wireless communication, and more particularly, to systems and methods for overhead reduction in wireless networks using space division multiple access (SDMA).

### BACKGROUND OF THE INVENTION

Space division multiple access (SDMA) is being used in wireless communication systems to improve the system's spectral efficiency. However, to enable SDMA, a base station has traditionally required information regarding the quality of the communication from the base station to the mobile user (downlink channel). That is, for existing SDMA implementations, the base station must be able to estimate the quality of the signal received by the remote subscriber unit so that a proper channel can be allocated for a particular air interface between a transmission point and a particular mobile user. For example, in a traditional SDMA implementation, the base station obtains the downlink channel information, such as magnitude and phase information, in order to form the beamforming vector so that the signal targeted to one user can be directed toward that particular user without interfering with other users.

Common methods for estimating downlink channel conditions, such as magnitude and phase, include: (1) assumption of downlink/uplink channel reciprocity; and (2) closed-loop feedback. The first method provides for estimating downlink quality using uplink quality, which the base station can determine from the incoming subscriber signal. However, due to possible differences in transmit and receive channels, the antenna array may need to be calibrated to compensate for phase inconsistencies. Not only may the calibration be expensive, but it may not even provide a solution in many implementations, since channel reciprocity does not hold for FDD systems. Closed-loop feedback of downlink channel information from a subscriber unit may require the use of a significant portion of the system bandwidth. Rapidly changing channel conditions, such as may be common in mobile applications, may drive the bandwidth cost even higher due to frequent channel quality reports.

### BRIEF SUMMARY OF THE INVENTION

Advantage is taken of the fact that the downlink quality is always known at the mobile station. Thus, the base station uses preference information from the mobile station as a basis for assigning an appropriate channel, rather than requiring the same degree of detail regarding channel conditions as would be required by a traditional SDMA system. In one embodiment, the base station pre-selects orthogonal beam-forming vectors for subcarriers and broadcasts the channels (subcarriers with different beamforming vectors) into different sectors of the region served by base station. The mobile stations then determine a priority (based for example on received quality) order of the codes of the received vectors. This priority order is sent uplink to the base station and the base station then, based on a priority listing of vectors from the mobile station, selects the downlink channel. The vectors may be established with some degree of randomness, or may be based on a desired beam coverage profile.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows a wireless communication system adapted to provide SDMA according to an embodiment of the invention;

FIG. 2A shows a method for reusing an SDMA subcarrier according to an embodiment of the invention;

FIG. 2B shows one embodiment of the control within a mobile device for determining beam preferences; and

FIG. 3 shows one embodiment of the base station beam-forming controller.

### DETAILED DESCRIPTION OF THE INVENTION

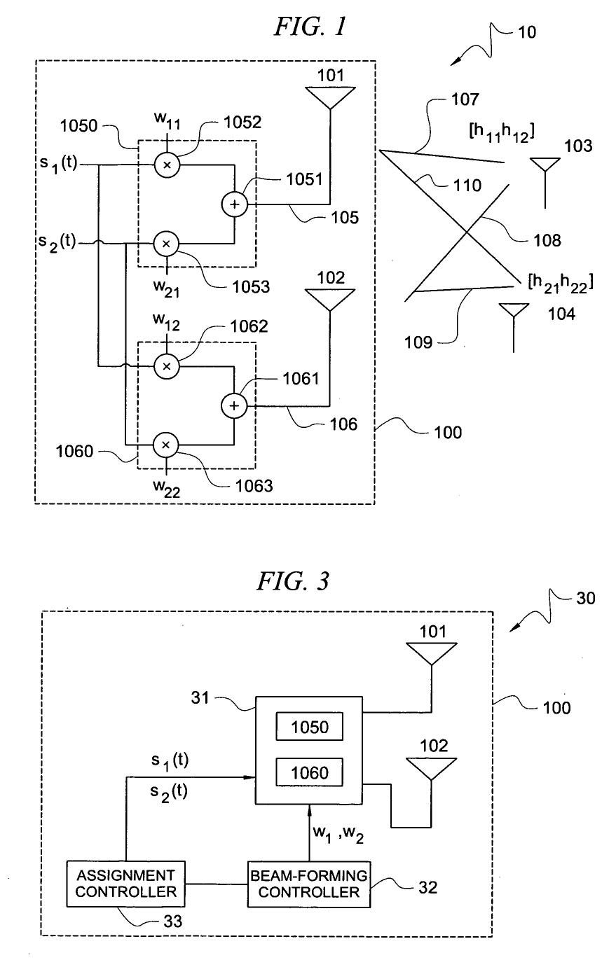

FIG. 1 shows one embodiment of wireless communication system 10 adapted to provide SDMA. Base station 100 comprises a plurality of antennas, shown here as antennas 101 and 102, although base station 100 may have any number of antennas in an array, or any number of arrays. Although embodiments of the invention may utilize any number of antennas and beams, the illustrated embodiment will be discussed with reference to the two antenna beams to simplify the discussion herein. As used herein, the term antenna means a phase center, and the term array means a collection of two or more phase centers.

Users 103 and 104 receive signals from base station 100, which is transmitting signals s₁ (t) and s₂ (t) using beam-forming vectors w₁=[w₁₁ w₁₂] and w₂=[w₂₁ w₂₂]. Signals s₁ (t) and s₂ (t) represent a single subcarrier that is to be transmitted in two different directions on two different beams. Base station 100 is shown transmitting two signals on the same subcarrier using the two beam-forming vectors, but may transmit any number of signals using an appropriate number of beam-forming vectors. For example, a base station may use N beam-forming vectors with N antennas to reuse a subcarrier by transmitting N signals on N beams. This allows reuse of a single subcarrier N times in a single cell.

Antenna 101 transmits signal 105, which is a complex weighted combination of w₁₁xs₁(t) and w₂₁xs₂ (t), combined by signal combiner 1050. (As used herein, “x” denotes either scalar or vector multiplication.) Antenna 102 transmits signal 106, which is a complex weighted combination of w₁₂xs₁(t) and w₂₂xs₂ (t), combined by signal combiner 1060. Signal combiner 1050 comprises summer 1051 and weighting elements 1052 and 1053. Weighting element 1052 scales signal s₁ by w₁₁, while weighting element 1053 scales signal s₂ by w₂₁ prior to 1051 combining the weighted signals. Similarly signal combiner 1060 comprises summer 1061 and weighting elements 1062 and 1063, and operates similarly to combiner 1050.

User 103 receives signal 105 from antenna 101 through downlink channel 107, having transfer function h₁₁ and signal 106 from antenna 102 through downlink channel 107, having transfer function h₁₂. User 103 then has a vector channel having transfer function h₁=[h₁₁h₁₂]^{T}. User 104 receives signal 106 from antenna 102 through downlink channel 109, having transfer function h₂₂ and signal 105 from antenna 101 through downlink channel 110, having transfer function h₂₁. User 104 has a vector channel having transfer function h₂=[h₂₁h₂₂]^{T}.

User 103 receives:

s₁(t)xw₁xh₁+s₂(t)xw₂xh₁=s₁(t)xw₁₁xh₁₁+s₁(t)xw₁₂xh₁₂+s₂(t)xw₂₁xh₁₁+s₂(t)xw₂₂xh₁₂.

Similarly, user 104 receives:

s₁(t)xw₁xh₂+s₂(t)xw₂xh₂=s₁(t)xw₁₁xh₂₁+s₁(t)xw₁₂xh₂₂+s₂(t)xw₂₁xh₂₁+s₂(t)xw₂₂xh₂₂.

For downlink transmission in an orthogonal frequency division multiple access (OFDMA) system, where base station 100 is equipped with multiple antennas, random orthogonal beam-forming vectors may be applied to each subcarrier or groups of subcarriers. Different subcarriers, or groups of subcarriers, may adopt different orthogonal beam-forming vectors. This results in a method of wireless communication which allows space division multiple access (SDMA) without requiring either downlink-uplink reciprocity calibration or closed-loop feedback of downlink channel information. Embodiments of the invention form a plurality of beams for downlink transmission and assigning one of the beams to a subscriber based on information received from that subscriber. Beams may be pre-formed, including random parameters, each with its own pilot data. Orthogonality among vectors reduces interference between different beams. Subscribers may determine the signal-to-interference ratios for one or more subcarriers and its associated beam-forming vector to feed back a subcarrier and beam preference. In this manner, two or more subscribers may use a signal subcarrier from a signal base station simultaneously.

Applied to the system shown in FIG. 1, beam-forming vector w₁ may be determined in any suitable manner, including some degree of randomness. Beam-forming vector w₂ may then be formed to be orthogonal to vector w₁.

Each user 103 and 104, being served by base station 100, may then provide preference information for specific subcarriers and beam-forming vectors back to a scheduler managing the communication of base station 100. Preference information may be based on signal-to-interference ratio (SIR) or signal-to-noise ratio (SNR), and may be abbreviated as compared with a closed-loop feedback system, as previously described. For example, feedback information may identify subcarriers and beam-forming vectors using only indices identified on pilot transmissions, rather than the same amount of vector channel information that would be required by a traditional closed-loop system. Also, no calibration is necessary to validate an assumption of reciprocity, since users 103 and 104 do provide at least some amount of feedback.

Even though beam-forming vectors w₁ and w₂ may be determined randomly, rather than calculated for any particular user, a typical cellular system may have enough different users that there should be a high probability that some users will align well with at least one of the beam-forming vectors. Since w₁ and w₂ are orthogonal, alignment with one of the beam-forming vectors, either w₁ or w₂, should result in low interference from the other. If a second user aligns well with the other beam-forming vector, two different users may share a single subcarrier, providing the benefits of SDMA. With an OFDMA channel scheduler at the base station which assigns subcarriers to users, at least in part, on user preferences, both OFDMA system multi-user diversity gain and SDMA gain may be achieved.

For the purposes of discussing FIG. 1, user 103 will be assumed to align perfectly with w₁, while user 104 aligns perfectly with w₂. This means that w₁xh₁=1, while w₂xh₁=0. Similarly, w₂xh₂=1, while w₁xh₂=0. Under this assumption, the signal received by user 103 is:

s₁(t)xw₁xh₁+s₂(t)xw₂xh₁=s₁(t)x1+s₂(t)x0=s₁(t).

Similarly, the signal received by user 104 is:

s₁(t)xw₁xh₂+s₂(t)xw₂xh₂=s₁(t)x0+s₂(t)x1=s₂(t).

Even without perfect alignment between h₁ and w₁, or between h₂ and w₂, user 103 will still receive s₁(t) at a considerably higher level than s₂(t), and user 104 will receive s₂(t) at a considerably higher level than s₁(t). Each user 103 and 104 may then have a relatively high SIR, allowing the scheduler at base station 100 to assign the same subcarrier to both.

When a user moves, such that the assigned subcarrier and beam-forming vector is no longer suitable, the base station scheduler may change the assignment, rather than adapting a beam-forming vector to the user's changed circumstances. This reduces the computational burden for providing SDMA.

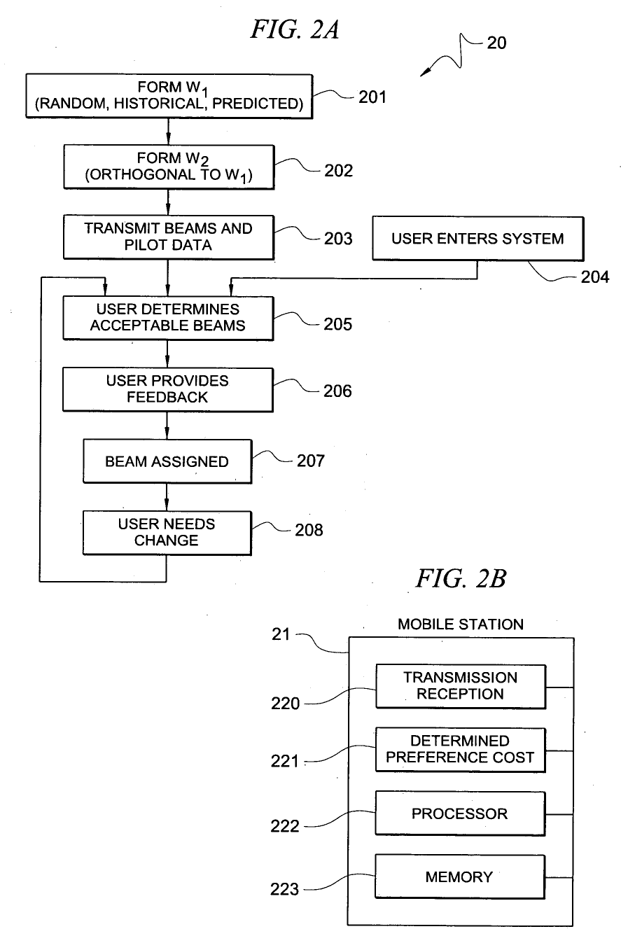

FIG. 2A shows one embodiment of a method, such as method 20, for assigning a subcarrier to a particular mobile station. Process 201 establishes beam-formed vector w₁ in any suitable manner. Similarly, beam-forming vector w₂ is established by process 202 such that w₂ is orthogonal to w₁. In process 203, the beams, along with pilot data, are transmitted to any mobile stations in the coverage area.

In process 204, a mobile station user enters the coverage area and, as shown by process 205, the user determines a preference hierarchy. This hierarchy can be based on many factors, such as SIR and SNR, but in any case represents a listing of best to worse beams for transmission purposes. In process 206, the user provides preference information to a scheduler or controller at the base station which then assigns a subcarrier and beam-forming vector combination to the user via process 207. The user's reception may change, as controlled by process 208, resulting in a return to process 205 to determine a new preference and thereby obtain a new beam assignment.

FIG. 2B shows one embodiment of a mobile device, such as device 21, adapted for determining beam preferences and for communicating that information to the base station. Device 21, for example, contains processor 222, and working in conjunction with algorithms contained in memory 223 controls the reception of beam data via receiver 220 and determines the list of qualities of the beams via 221. The list can be according to coded identities for each beam and/or subcarrier. The ordered list of identities can then be transmitted uplink by transmitter 220.

FIG. 3 shows base station 100 comprising beam former 31, beam-forming controller 32, and assignment controller 33. Beam former 31 comprises signal combiners 1050 and 1060, discussed above. Beam-forming controller 32 provides beam-forming vectors w₁ and w₂ to beam former 31. Assignment controller 33 associates signals, such as s₁(t) and s₂(t), with the proper beam-forming vector.

For many cells, sets of beam-forming vectors may be selected based on historical or predicted user location densities. In some situations, a particular beam-forming vector may be unsuitable for use if there is no user in need of service in the area served by that beam-forming vector. That is, with pre-formed beams, a particular beam may only find use when a user needing service is in the correct location. For a traditional SDMA system using custom-formed beams, however, while there may be a potential for more efficient reuse, it comes at the cost of increased user feedback requirements that use system bandwidth. One possible way to pre form the beamforming vector is to let the direction of beams on different subcarriers be uniformly cover all possible directions uniformly or evenly-spaced. Another possible way is to randomly choose orthogonal vectors for each subcarrier. When the number of subcarriers in the system is large, this should provide good coverage for all directions. When the number of users is large, each subcarrier will likely be acceptable for some users, providing SDMA without the bandwidth requirements of traditional implementations.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of wireless communication comprising:
pre-forming a first set of beams for Space Division Multiple Access (SDMA) downlink transmission;
pre-forming for beam in said first set of beams at least one other beam orthogonal to each of said first set of pre-formed beams for downlink transmission;
transmitting all of said pre-formed beams downlink to a plurality of possible mobile stations; and
assigning one of said pre-formed beams to a subscriber based on said subscriber's feedback as to which of said pre-formed beams is acceptable.

2. The method of claim 1 wherein said feedback contains an order of acceptable beams ranked in order of acceptable quality level.

3. The method of claim 2 wherein said quality is selected from the list of: SNR, SIR.

4. The method of claim 2 wherein said quality is determined by said mobile stations.

5. The method of claim 1 wherein said beams are fixed.

6. The method of claim 1 further comprising:
assigning a second one of said plurality of beams to said subscriber in response to said subscriber moving out of a coverage area of said first beam, said second assignment made based on a new ranked order of quality as received from said mobile station.

7. The method of claim 1 further comprising:
transmitting an index for each of said pre-formed beams, said index serving to identify each said beam.

8. The method of claim 7 wherein said feedback comprises said ranked order is in terms of said index.

9. The method of claim 1 further comprising:
changing said assignment in response to a change in said subscriber feedback.

10. The method of claim 1 wherein each of said beams has its own pilot data.

11. The method of claim 1 wherein two or more subscribers in different locations use a same subcarrier from a single base station.

12. The method of claim 1 wherein said pre-forming comprises methods selected from the following list:
using random parameters;
using predicted mobile station locations;
using historical mobile station locations; and
combinations of one or more of from this list.

13. A system for wireless communication comprising:
means for forming a plurality of beams for Space Division Multiple Access (SDMA) downlink transmission of Orthogonal Frequency Division Multiple Access (OFDMA) subcarriers, wherein said beams are pre-formed using predetermined beam-forming vectors; and
means for assigning one of said pre-formed beams to a subscriber based on subscriber feedback, wherein said feedback identifies one or more of said pre-formed beams as acceptable.

14. The system of claim 13 wherein said beams are fixed.

15. The system of claim 13 wherein said pre-forming comprises using predicted or historical subscriber locations in deciding how to form said beams.

16. The system of claim 1 further comprising:
means for transmitting pilot data in conjunction with each said beam, said pilot data operable for assisting said subscriber in identifying to said system acceptable ones of said beams.

17. A mobile device for use with an air interface communication system, said mobile device comprising:
means for receiving from a transmission point signal channels from a transmission point, each received signal channel being communicated using a particular communication channel distinguishable from the other channels;
means for identifying which channel has the highest quality; and
means for communicating the identity of said identified highest quality channel to said transmission point.

18. The device of claim 17 further comprising:
means for rank ordering at least some of said received channels in order of quality of received service.

19. The device of claim 18 further comprising:
means for transmitting said rank order to said transmission point.

20. The device of claim 19 wherein said quality is determined based on determinations of factors selected from the list of: SIR, SNR.

19. A method of wireless communication comprising:
predicting at least one likely subscriber location;
forming a first beam to cover one of said predicted locations;
forming at second beam orthogonal to said first beam; and
assigning one of said first and second beams based on subscriber feedback, wherein said feedback identifies said first or second beam using an index associated with said first or second beam.

20. The method of claim 19 wherein said beams are fixed.

21. The system of claim 19 further comprising:
changing said assignment in response to a change in said subscriber feedback.
